(19) United States
(12) Patent Application Publication
(10) Pub. No.: US 2006/0110634 A1
(43) Pub. Date: May 25, 2006

(54) Method and apparatus for preventing condensation in cathode exhaust conduit of fuel cell

(76) Inventors: Volker Formanski, Wiesbaden (DE); Robert Schafer, Darmstadt (DE); Marc Becker, Idstein (DE); Dirk Wexel, Mainz-Kastel (DE)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/997,459

(22) Filed: Nov. 24, 2004

(51) Int. Cl. H01M 8/00; H01M 2/02; H01M 2/36

(52) U.S. Cl. 429/13; 429/34; 429/72

(57) ABSTRACT

A method and apparatus for preventing or at least reducing condensation in a cathode exhaust conduit of a fuel cell is disclosed. The method includes introducing air into the fuel cell through an air intake conduit, removing an exhaust stream from the fuel cell through the cathode exhaust conduit and introducing excess air into the cathode exhaust conduit to prevent or reduce condensation of the exhaust stream in the cathode exhaust conduit. The apparatus includes an air intake conduit for introducing air into the fuel cell, a cathode exhaust conduit for distributing the exhaust stream from the fuel cell and an excess air diversion conduit providing fluid communication between the air intake conduit and the cathode exhaust conduit for diverting air from the air intake conduit and the cathode exhaust conduit.

### TECHNICAL FIELD

The present invention relates to fuel cell vehicles which utilize an electrolyte polymer membrane interposed between a cathode and an anode to generate electricity as electrons are stripped from hydrogen atoms to form protons prior to passage of the protons through the membrane. More particularly, the present invention relates to a method and apparatus for preventing or at least reducing condensation of water in a cathode exhaust conduit of a fuel cell by introducing air into the cathode exhaust conduit during operation of the fuel cell.

### BACKGROUND OF THE INVENTION

Fuel cell technology is a relatively recent development in the automotive industry. It has been found that fuel cell power plants are capable of achieving efficiencies as high as 55%. Furthermore, fuel cell power plants emit no harmful by-products which would otherwise contribute to atmospheric pollution.

Fuel cells include three components: a cathode, ananode and an electrolyte which is sandwiched between the cathode and the anode and passes only protons. Each electrode is coated on one side by a catalyst. In operation, the catalyst on the anode splits hydrogen into electrons and protons. The electrons are distributed as electric current from the anode, through a drive motor and then to the cathode, whereas the protons migrate from the anode, through the electrolyte to the cathode. The catalyst on the cathode combines the protons with electrons returning from the drive motor and oxygen from the air to form water. Individual fuel cells can be stacked together in series to generate increasingly larger quantities of electricity.

In a Polymer-Electrolyte-Membrane (PEM) fuel cell, a polymer membrane serves as the electrolyte between a cathode and an anode. The polymer membrane currently being used in fuel cell applications requires a certain level of humidity to facilitate conductivity of the membrane. Therefore, maintaining the proper level of humidity in the membrane, through humidity/water management, is very important for the proper functioning of the fuel cell. Irreversible damage to the fuel cell will occur if the membrane dries out.

During the conversion of hydrogen and oxygen (air) to electricity, water is produced as a reaction by-product. The product water is removed from the fuel cell by a cathode exhaust conduit. Due to the moist operation conditions of the fuel cell, the operating parameters are chosen in such a manner that certain water saturation is reached at the cathode outlet.

Depending on the arrangement or design of the fuel cell system, the water in the cathode exhaust can be utilized within the fuel cell system. This assists in the water management of fuel cells used in mobile applications. Depending on the conditioning of the cathode exhaust, small heat loss to the environment and condensation of the reaction product water coming from the fuel cell cannot be prevented. However, the inclusion of large quantities of liquid water must be avoided for proper operation of the fuel cell. At lower environmental temperatures, the heat loss and condensation will increase. Therefore, during winter operation of a vehicle, the formation of ice within the exhaust stream is a possibility and must be avoided.

In fuel cell systems currently being developed, the cathode exhaust stream leaves the cathode exhaust conduit in a certain saturated state. With environmental temperatures falling as low as −25 degrees C. in many winter climates, such emission of the cathode exhaust stream from the cathode exhaust conduit in a saturated state renders the development of fuel cells for vehicles problematic. FIG. 1 shows the essential operation characteristic features of a fuel cell under selected fuel cell system load operating conditions. For an operating temperature of 80 degrees C., a dew point temperature (dotted line) of 63 degrees C. is realistic. The heat transfer coefficient (solid line) for the cathode exhaust ranges from 5 to 50 kW/m² K.

The dashed line in FIG. 1 depicts the environmental temperatures that correspond to the minimal temperatures at which condensation of water in the cathode exhaust conduit would occur, given the selected fuel cell system load operating conditions. In the graph, a system load of 0.0 indicates no load, whereas a system load of 1.0 indicates maximum load. With increased system load, fuel cell operation results in condensation of water at progressively lower environmental temperatures. According to the graph, environmental temperatures of approximately 40 degrees C. and lower would lead to undesirable levels of condensation of the cathode exhaust stream in the cathode exhaust conduit throughout the operating range of the fuel cell. Therefore, the low environmental temperatures which are characteristic of winter temperatures in many climates would render the operation of fuel cells problematic in such climates. Thus, a method and apparatus are needed to reduce condensation of a cathode exhaust stream in a cathode exhaust conduit of a fuel cell.

### SUMMARY OF THE INVENTION

The present invention is generally directed to a novel method for reducing condensation of a cathode exhaust stream in a cathode exhaust conduit of a fuel cell. The method includes the introduction of air into the cathode exhaust conduit during fuel cell operation in order to reduce the partial pressure of the exhaust water vapor in the exhaust stream, and therefore, reduce the dew point temperature of the cathode exhaust stream. Consequently, the tendency of the cathode exhaust stream to condense from the vaporized state into the liquid state in the cathode exhaust conduit is reduced. This enables operation of the fuel cell without excessive condensation of the exhaust stream in the cathode exhaust conduit, particularly at reduced environmental temperatures. The method may further include pre-heating of the cathode exhaust stream to further reduce condensation of the cathode exhaust stream in the cathode exhaust conduit.

The present invention is further directed to a novel apparatus for reducing condensation of a cathode exhaust stream in a cathode exhaust conduit of a fuel cell. The apparatus includes an air inlet conduit for distributing oxygen to a cathode in a polymer-electrolyte-membrane (PEM) fuel cell. A cathode exhaust conduit extends from the fuel cell to carry an exhaust stream from the cathode. An excess air diversion conduit extends from the air inlet conduit to the cathode exhaust conduit. During operation of the fuel cell, excess air is diverted from the air inlet conduit to the cathode exhaust conduit in order to reduce condensation of the exhaust stream in the cathode exhaust conduit by reducing the partial pressure of the exhaust stream. A heating element may be provided in thermal contact with the cathode exhaust conduit to pre-heat the exhaust stream prior to mixing of the exhaust stream with the excess air.

In the graph of FIG. 6, the impact of adding excess air to the cathode exhaust on the dew point temperature is shown. The upper dashed line represents the dew point before mixing excess air to the cathode exhaust. The middle or sloped line shows the excess air mixed with the cathode exhaust. This mixing of the excess air with the cathode exhaust leads to an allowable ambient temperature of −20° C., which is represented by the bottom dashed line. Accordingly, feeding excess air to the cathode exhaust reduces the allowable ambient temperature from 40 . . . 3° C. (function of system load) to −20° C. over the complete operation range.

### BRIEF DESCRIPTION OF THE DRAWINGS

The invention will now be described, by way of example, with reference to the accompanying drawings, in which:

FIG. 1 is a graph which illustrates typical operating data for a standard fuel cell system;

FIG. 2 is a schematic view of an air intake and exhaust conduit system for a fuel cell provided with an excess air supply system according to the present invention;

FIG. 3 is a graph which illustrates typical fuel cell operating data of a fuel cell system with additional electrical heating of the exhaust stream without the effect of excess air in the exhaust conduit of the system, according to the present invention;

FIG. 4 is a schematic view of an air intake and exhaust conduit system for a fuel cell provided with an alternative excess air supply system according to the present invention;

FIG. 5 is a schematic view of an air intake and exhaust conduit system for a fuel cell provided with another alternative excess air supply system according to the present invention; and

FIG. 6 is a graph which illustrates typical fuel cell operating data of a fuel cell system with the effect of feeding excess air into the exhaust conduit of the system according to the present invention, wherein the upper dashed line is the dew point before mixing excess air to the cathode exhaust and the middle (sloped) line is the excess air mixed with cathode exhaust leading to an allowable ambient temperature of −20 degrees C. (represented by the lower dashed line).

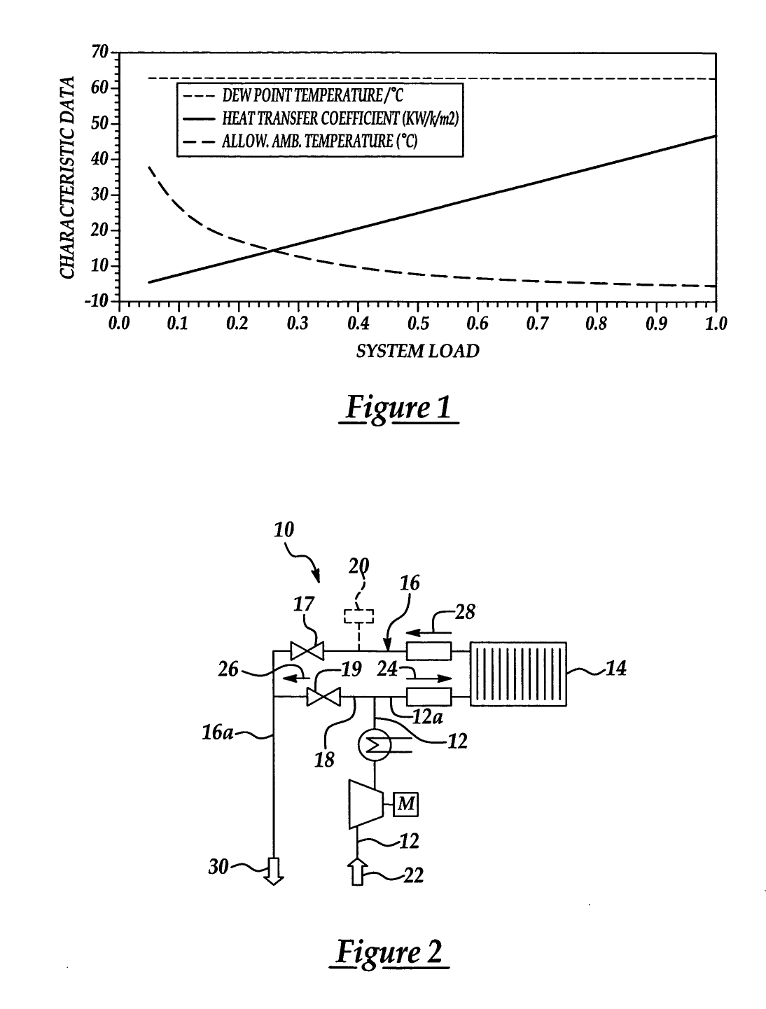

### DESCRIPTION OF THE PREFERRED EMBODIMENTS

Referring initially to FIG. 2, an air intake and exhaust conduit system for a fuel cell according to the present invention is generally indicated by reference numeral 10. The system 10 includes a polymer-electrolyte-membrane (PEM) fuel cell 14, which may be conventional and includes a cathode (not shown), an anode (not shown) and an electrolyte membrane (not shown) sandwiched between the cathode and the anode. An air intake conduit 12 is provided for receiving a continuous air stream 22 from an air compressor (is shown without a number). An inlet segment 12a branches from the air intake conduit 12 and is provided in fluid communication with the cathode of the PEM fuel cell 14. A valve 17 may be provided in the cathode exhaust conduit 16 to control the rate of flow of the exhaust gas stream through the cathode exhaust conduit 16. A downstream segment 16a of the cathode exhaust conduit 16 may extend from the outlet of the valve 17.

According to the present invention, an excess air diversion conduit 18 branches from the air intake conduit 12, typically at the inlet segment 12a, and is provided in fluid communication with the downstream segment 16a of the cathode exhaust conduit 16. A valve 19 may be provided in the excess air diversion conduit 18 for purposes which will be hereinafter described.

During operation of the PEM fuel cell 14, a continuous air stream 22 is distributed from the air compressor (shown without number) through the air intake conduit 12. Operating air from the air stream 22 is distributed by the inlet segment 12a into the fuel cell 14, whereas excess air 26 from the air stream 22 is distributed by the excess air diversion conduit 18 into the downstream segment 16a of the cathode exhaust conduit 16. In the PEM fuel cell 14, a catalyst coated on the anode (not shown) splits hydrogen into electrons and protons. The electrons from the hydrogen are distributed as electric current from the anode, through a drive motor (not shown) and then to the cathode (not shown), whereas the protons migrate from the anode, through the electrolyte membrane (not shown) to the cathode. The catalyst on the cathode combines the protons with electrons returning from the drive motor and oxygen from the operating air to form the exhaust gas stream 28. The cathode exhaust conduit 16 and downstream segment 16a distribute the exhaust stream 28, in vapor form, from the PEM fuel cell 14.

As the exhaust stream 28 flows through the downstream segment 16a of the cathode exhaust conduit 16, the excess air 26 flowing into the downstream segment 16a from the excess air diversion conduit 18 combines and mixes with the vaporized exhaust gas 28. The excess air 26 reduces the partial vapor pressure of the exhaust gas 28 in the downstream segment 16a. This lowers the dew point of the exhaust stream 28 and prevents condensation of the exhaust stream 28 from the vapor to the liquid state in the downstream segment 16a. Accordingly, the downstream segment 16a discharges the excess air 26 and exhaust stream 28 into the atmosphere as a vaporized air/water mixture 30. It is understood that the excess air 26 can be introduced into any portion of the cathode exhaust conduit 16 or downstream segment 16a thereof from either the excess air diversion conduit 18, as heretofore described, or from an air source (not shown) which is separate from the air stream 22.

The quantity of excess air 26 which is required to maintain the exhaust stream 28 in a vaporized state throughout the downstream segment 16a depends in large part on the loss of heat from the exhaust stream 28. The quantity of excess air 26 which is required can be reduced if the cathode exhaust conduit 16 is properly insulated to minimize the quantity of heat loss. Furthermore, the quantity of excess air 26 necessary to maintain the exhaust stream 28 in a vaporized state is typically inversely related to the ambient temperature, with larger quantities of excess air 26 necessary in colder ambient temperatures.

Referring again to FIG. 2, a heating element 20 (shown in phantom) may optionally be provided in thermal contact with the cathode exhaust conduit 16, according to the knowledge of those skilled in the art, to heat the exhaust stream 28 flowing therethrough and maintain the exhaust stream 28 in the vaporized state. Accordingly, the heat applied to the exhaust stream 28 using the heating element 20, in combination with the excess air 26 applied to the exhaust stream 28, maintains the exhaust stream 28 in the vaporized state as the excess air 26 mixes with the exhaust stream 28 and the air/water mixture 30 is discharged from the downstream segment 16a.

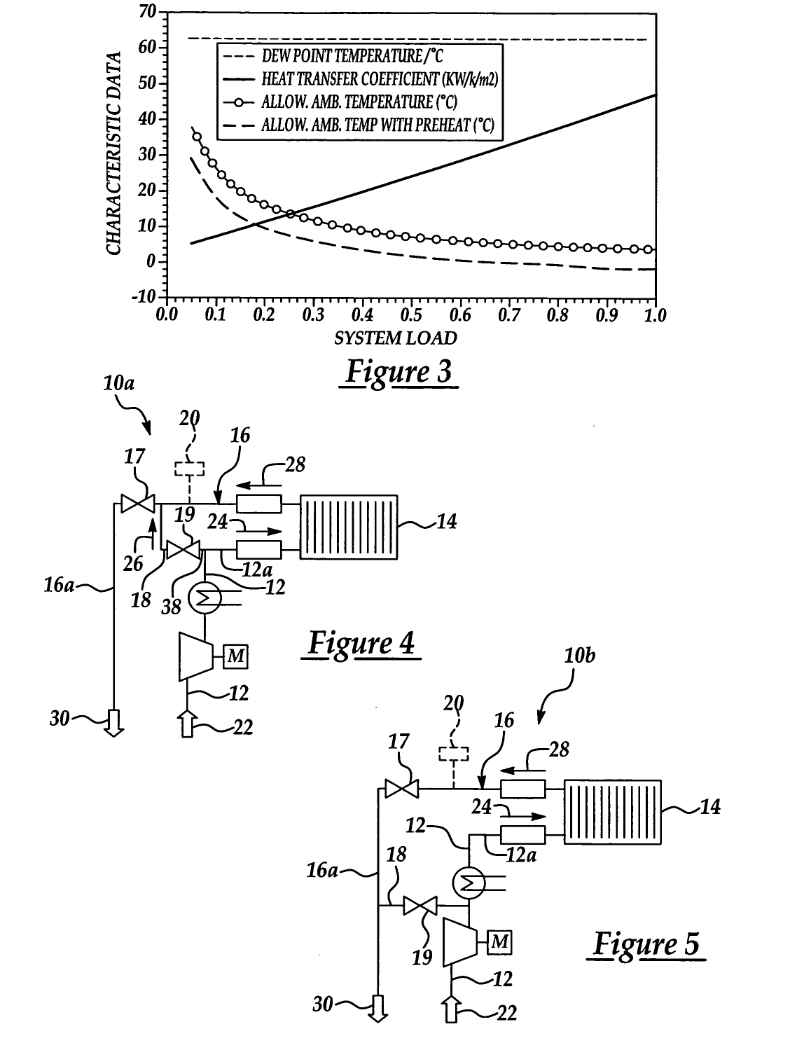

The graph of FIG. 3 illustrates typical fuel cell operating data of a fuel cell system with additional electrical heating of the exhaust stream 28 in the cathode exhaust conduit 16, according to the present invention. The line-connected circles indicate the allowable ambient temperatures for operation of the fuel cell 14 using the flow of excess air 26 to the downstream segment 16a, without heating of the exhaust stream 28 using the heating element 20, throughout the system load range of the fuel cell 14. Accordingly, such operation of the fuel cell 14 without operation of the heating element 20 is effective to prevent condensation of the exhaust stream 28 to a temperature range as low as from about 40 degrees C. to about 5 degrees C., as indicated by the line-connected circles. On the other hand, operation of the fuel cell 14 using the heating element 20 to pre-heat the exhaust stream 28, in addition to distribution of the excess air 26 into the downstream segment 16a, is effective to prevent condensation of the exhaust stream 28 to a temperature range as low as from about 30 degrees C. to about −1 degrees C. over the system load range of the fuel cell 14.

Referring next to FIG. 4, an alternative air intake and exhaust conduit system for a fuel cell according to the present invention is generally indicated by reference numeral 10a. The system 10a is similar in design to the system 10 heretofore described with respect to FIG. 2, except that the excess air diversion conduit 18 is provided in fluid communication with the segment of the cathode exhaust conduit 16 which is upstream of the valve 17, instead of with the downstream segment 16a of the cathode exhaust conduit 16. Operation of the system 10a, with or without the heating element 20, is similar to that described with respect to the system 10. The heating element 20 is optional and may be provided in thermal contact with the cathode exhaust conduit 16, according to the knowledge of those skilled in the art.

Referring next to FIG. 5, a preferred embodiment of the air intake and exhaust conduit system for a fuel cell according to the present invention is generally indicated by reference numeral 10b. The system 10b is similar in design to the system 10 heretofore described with respect to FIG. 2, except that the excess air diversion conduit 18 branches from the air intake conduit 12 upstream of the inlet segment 12a. A heating element 20 may optionally be provided in thermal contact with the cathode exhaust conduit 16, according to the knowledge of those skilled in the art. Operation of the system 10a, with or without the heating element 20, is similar to that described with respect to the system 10.

In the embodiments shown in FIGS. 4 and 5, excess air is supplied to the cathode exhaust conduit 16 from a port between the air compressor and charge air cooler in the air intake conduit 12. This results in additional heat being supplied to the exhaust stream in the cathode exhaust conduit 16.

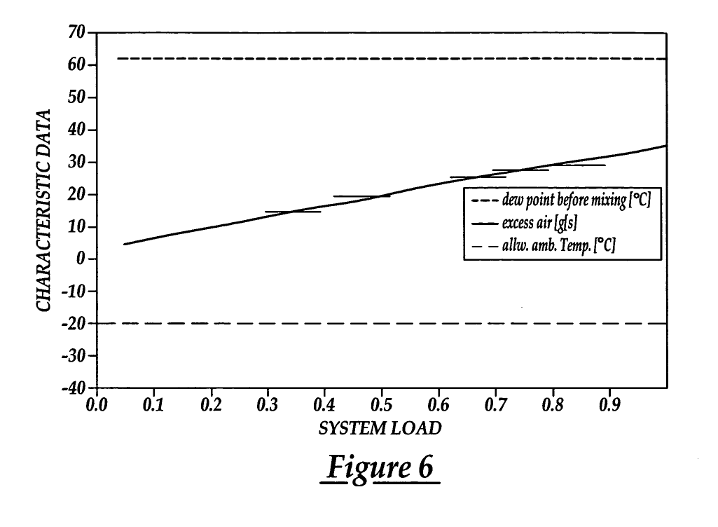

Referring next to the graph of FIG. 6, the effect of adding excess air to the cathode exhaust on the dew point temperature of the exhaust is shown. The upper dashed line represents the dew point (° C.) before mixing excess air to the cathode exhaust. The middle or sloped line represents the excess air (g/s) mixed with the cathode exhaust. This mixing of the excess air with the cathode exhaust leads to an allowable ambient temperature of −20° C., which is represented by the bottom dashed line. Accordingly, feeding excess air to the cathode exhaust reduces the allowable ambient temperature from 40 . . . 3° C. (function of system load) to −20° C. over the complete operation range.

While the preferred embodiments of the invention have been described above, it will be recognized and understood that various modifications can be made in the invention and the appended claims are intended to cover all such modifications which may fall within the spirit and scope of the invention.

1. A method for preventing or at least reducing condensation in a cathode exhaust conduit of a fuel cell, comprising:
introducing an air stream into said fuel cell;
removing an exhaust stream from said fuel cell through said cathode exhaust conduit; and
preventing water vapor from condensing in said cathode exhaust conduit by introducing a second air stream into said cathode exhaust conduit in a quantity which is inversely proportional to an ambient temperature.

2. The method of claim 1 wherein said introducing a second air stream into said cathode exhaust conduit comprises providing an air intake conduit, introducing said second air stream into said fuel cell through said air intake conduit and diverting said second air stream from said air intake conduit into said cathode exhaust conduit

3. The method of claim 1 wherein said introducing a second air stream into said cathode exhaust conduit comprises introducing said second air stream into said cathode exhaust conduit at a variable flow rate >0 g/s.

4. The method of claim 3 wherein said introducing said second air stream into said cathode exhaust conduit comprises providing an air intake conduit, introducing said second air stream into said fuel cell through said air intake conduit and diverting said second air stream from said air intake conduit into said cathode exhaust conduit.

5. The method of claim 1 further comprising heating said exhaust stream in said cathode exhaust conduit.

6. The method of claim 5 wherein said introducing a second air stream into said cathode exhaust conduit comprises providing an air intake conduit, introducing said second air stream into said fuel cell through said air intake conduit and diverting said second air stream from said air intake conduit into said cathode exhaust conduit.

7. The method of claim 5 wherein said introducing a second air stream into said cathode exhaust conduit comprises introducing said second air stream into said cathode exhaust conduit at a variable flow rate >0 g/s.

8. The method of claim 7 wherein said introducing a second air stream into said cathode exhaust conduit comprises providing an air intake conduit, introducing said second air stream into said fuel cell through said air intake conduit and diverting said second air from said air intake conduit into said cathode exhaust conduit.

9. A method for preventing condensation in a cathode exhaust conduit of a fuel cell having an air intake conduit, comprising:
introducing an air stream into said air intake conduit;
diverting operating air from said air stream into said fuel cell;
diverting excess air from said air stream into said cathode exhaust conduit in a quantity which is inversely proportional to an ambient temperature; and
removing an exhaust stream from said fuel cell through said cathode exhaust conduit, whereby said excess air substantially prevents condensation of said exhaust stream in said cathode exhaust conduit.

10. The method of claim 9 wherein said diverting operating air from said air stream and said diverting excess air from said air stream are simultaneous.

11. The method of claim 9 wherein said introducing excess air into said cathode exhaust conduit comprises introducing excess air into said cathode exhaust conduit at a variable flow rate of >0 g/s.

12. The method of claim 11 wherein said diverting operating air from said air stream and said diverting excess air from said air stream are simultaneous.

13. The method of claim 9 further comprising heating said exhaust stream in said cathode exhaust conduit.

14. The method of claim 13 wherein said diverting operating air from said air stream and said diverting excess air from said air stream are simultaneous.

15. The method of claim 13 wherein said introducing excess air into said cathode exhaust conduit comprises introducing excess air into said cathode exhaust conduit at a variable flow rate of >0 g/s.

16. The method of claim 15 wherein said diverting operating air from said air stream and said diverting excess air from said air stream are simultaneous.

17. An apparatus for preventing condensation of an exhaust stream from a fuel cell, comprising:
an air intake conduit for introducing air into the fuel cell;
a cathode exhaust conduit for distributing the exhaust stream from the fuel cell; and
an excess air diversion conduit providing fluid communication between said air intake conduit and said cathode exhaust conduit for diverting air from said air intake conduit and said cathode exhaust conduit.

18. The apparatus of claim 17 further comprising a valve provided in said excess air diversion conduit.

19. The apparatus of claim 17 further comprising a heating element provided in thermal contact with said cathode exhaust conduit for heating the exhaust stream in said cathode exhaust conduit.

20. The apparatus of claim 19 further comprising a valve provided in said excess air diversion conduit.

21. An apparatus for preventing condensation of an exhaust stream from a fuel cell, comprising:
an air intake conduit for introducing air into the fuel cell;
a compressor and a charge air cooler provided in said air intake conduit;
a port provided in said air intake conduit between said compressor and said charge air cooler;
a cathode exhaust conduit for distributing the exhaust stream from the fuel cell; and
an excess air diversion conduit providing fluid communication between said port and said cathode exhaust conduit for diverting air from said air intake conduit to said cathode exhaust conduit.
